(19) United States
(12) Patent Application Publication
(10) Pub. No.: US 2010/0304751 A1
(43) Pub. Date: Dec. 2, 2010

(54) SYSTEM AND METHOD FOR UPLINK COORDINATED MULTIPOINT RECEPTION OPERATION

(75) Inventors: Baowei Ji, Plano, TX (US); Farooq Khan, Allen, TX (US); Zhouyue Pi, Allen, TX (US); Jianzhong Zhang, Irving, TX (US)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/707,390

(22) Filed: Feb. 17, 2010

Related U.S. Application Data
(60) Provisional application No. 61/217,506, filed on Jun. 1, 2009.

(51) Int. Cl. H04W 72/04

(52) U.S. Cl. 455/450

(57) ABSTRACT

A wireless network includes a serving base station and a plurality of non-serving base stations which are capable of performing a coordinated multipoint communication with at least one subscriber station. A non-serving base station includes at least one antenna configured to overhear a data burst from the subscriber station to a serving base station. The non-serving base station can decode the data burst locally. If the data burst is successfully decoded, the controller forwards the decoded data burst to the serving base station. The serving base station can decode the data burst locally or jointly decode the data burst from the non-serving base station.

### CROSS-REFERENCE TO RELATED APPLICATION(S) AND CLAIM OF PRIORITY

The present application is related to U.S. Provisional Patent Application No. 61/217,506, filed Jun. 1, 2009, entitled “METHOD FOR UL CoMP OPERATION”. Provisional Patent Application No. 61/217,506 is assigned to the assignee of the present application and is hereby incorporated by reference into the present application as if fully set forth herein. The present application hereby claims priority under 35 U.S.C. §119(e) to U.S. Provisional Patent Application No. 61/217,506.

### TECHNICAL FIELD OF THE INVENTION

The present application relates generally to wireless communications and, more specifically, to a system and method for uplink coordinated multipoint communications.

### BACKGROUND OF THE INVENTION

In a wireless communications network, multiple cells or base stations (also referred to as “eNBs”) use frequency bands and standardized codebooks for precoding transmission to their respective user equipments (UEs), using multiple transmit antennas. A typical problem of this procedure occurs where several cells or base stations are serving their intended UEs while interfering with each other's signal. This scenario is called “inter-cell interference.” Inter-cell interference constrains the throughput of the wireless network.

In an uplink (UL) coordinated multipoint reception (CoMP) operation a subscriber station (SS) can communicate with a serving base station (s-BS), also referred to as the anchor base station (BS), for the SS and a non-serving BS (ns-BS). The SS transmits a data burst to the s-BS as instructed by the s-BS. The ns-BS, which is informed of this event by the s-BS in advance, overhears the transmission and forwards the signal to the s-BS. The s-BS jointly processes the signals, and ACKs or NACKs the SS dependent upon whether the joint decoding is successful or not.

### SUMMARY OF THE INVENTION

A base station capable of performing a coordinated multipoint communication with at least one subscriber station is provided. The base station includes at least one antenna configured to receive a signal. The signal comprising a data burst from the at least one subscriber station to a serving base station. The base station also includes controller coupled to the at least one antenna. The controller is configured to decode the data burst locally. If the data burst is successfully decoded, the controller forwards the decoded data burst to the serving base station.

A base station capable of performing a coordinated multipoint communication with at least one subscriber station is provided. The base station includes at least one antenna configured to receive a data burst from the at least one subscriber station. The base station also includes a controller coupled to the at least one antenna. The controller is configured to at least one of: decode the data burst locally; if unable to successfully decode the data burst, receive the data burst or decoded data from a second base station.

A method for performing a coordinated multipoint communication with at least one subscriber station is provided. The method includes receiving a signal comprising a data burst from the at least one subscriber station to a serving base station. The method also includes decoding the data burst locally; and if the data burst is successfully decoded, forwarding the decoded data burst to the serving base station.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates exemplary wireless network 100 that is capable of decoding data streams according to embodiments of the disclosure;

FIG. 2 illustrates exemplary base station in greater detail according to embodiments of the present disclosure;

FIG. 3 illustrates an exemplary wireless mobile station according to embodiments of the present disclosure;

FIGS. 4A and 4C illustrate an architecture of a CoMP operation according to the disclosure;

FIG. 4B and 4D illustrate processes for a CoMP operation according to embodiments of the present disclosure;

FIGS. 5 through 14 illustrate processes CoMP operations according to embodiments of the present disclosure;

FIG. 15 illustrates overlapped resource allocations in a CoMP operation according to embodiments of the present disclosure;

FIG. 16 illustrates different subchannelization schemes that can be utilized by base stations in a CoMP operation according to embodiments of the present disclosure;

FIG. 17 illustrates a signal cancellation in an ns-BS according to embodiments of the present disclosure; and

FIG. 18 illustrates a signal cancellation process in an ns-BS according to embodiments of the present disclosure.

### DETAILED DESCRIPTION OF THE INVENTION

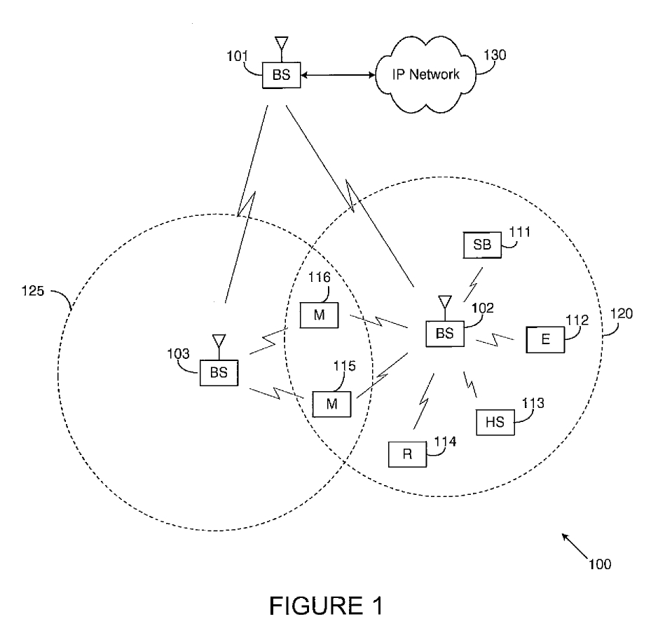

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

With regard to the following description, it is noted that the LTE term “node B” is another term for “base station” used below. Further, the term “cell” is a logic concept that can represent a “base station” or a “sector” belongs to a “base station”. In the present disclosure, “cell” and “base station” are used interchangeably to indicate the actual transmission units (may be “sector” or “base station” and the like) in the wireless system. Also, the LTE term “user equipment” or “UE” is another term for “subscriber station” used below. It is noted that in all the following figures, some optional features are explicitly marked while some are omitted for clarity purpose.

FIG. 1 illustrates exemplary wireless network 100 that is capable of decoding data streams according to one embodiment of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Base station 102 provides wireless broadband access to network 130, via base station 101, to a first plurality of subscriber stations within coverage area 120 of base station 102. The first plurality of subscriber stations includes subscriber station (SS) 111, subscriber station (SS) 112, subscriber station (SS) 113, subscriber station (SS) 114, subscriber station (SS) 115 and subscriber station (SS) 116. Subscriber station (SS) may be any wireless communication device, such as, but not limited to, a mobile phone, mobile PDA and any mobile station (MS). In an exemplary embodiment, SS 111 may be located in a small business (SB), SS 112 may be located in an enterprise (E), SS 113 may be located in a WiFi hotspot (HS), SS 114 may be located in a residence, SS 115 may be a mobile (M) device, and SS 116 may be a mobile (M) device.

Base station 103 provides wireless broadband access to network 130, via base station 101, to a second plurality of subscriber stations within coverage area 125 of base station 103. The second plurality of subscriber stations includes subscriber station 115 and subscriber station 116. In alternate embodiments, base stations 102 and 103 may be connected directly to the Internet or other controller unit by means of a wired broadband connection, such as an optical fiber, DSL, cable or T1/E1 line, rather than indirectly through base station 101.

In other embodiments, base station 101 may be in communication with either fewer or more base stations. Furthermore, while only six subscriber stations are shown in FIG. 1A, it is understood that wireless network 100 may provide wireless broadband access to more than six subscriber stations. It is noted that subscriber station 115 and subscriber station 116 are on the edge of both coverage area 120 and coverage area 125. Subscriber station 115 and subscriber station 116 each communicate with both base station 102 and base station 103 and may be said to be cell-edge devices interfering with each other. For example, the communications between BS 102 and SS 116 may be interfering with the communications between BS 103 and SS 115. Additionally, the communications between BS 103 and SS 115 may be interfering with the communications between BS 102 and SS 116.

In an exemplary embodiment, base stations 101-103 may communicate with each other and with subscriber stations 111-116 using an IEEE-802.16 wireless metropolitan area network standard, such as, for example, an IEEE-802.16e standard. In another embodiment, however, a different wireless protocol may be employed, such as, for example, a HIPERMAN wireless metropolitan area network standard. Base station 101 may communicate through direct line-of-sight or non-line-of-sight with base station 102 and base station 103, depending on the technology used for the wireless backhaul. Base station 102 and base station 103 may each communicate through non-line-of-sight with subscriber stations 111-116 using OFDM and/or OFDMA techniques.

Base station 102 may provide a T1 level service to subscriber station 112 associated with the enterprise and a fractional T1 level service to subscriber station 111 associated with the small business. Base station 102 may provide wireless backhaul for subscriber station 113 associated with the WiFi hotspot, which may be located in an airport, café, hotel, or college campus. Base station 102 may provide digital subscriber line (DSL) level service to subscriber stations 114, 115 and 116.

Subscriber stations 111-116 may use the broadband access to network 130 to access voice, data, video, video teleconferencing, and/or other broadband services. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber station 114 may be, for example, a wireless-enabled personal computer, a laptop computer, a gateway, or another device.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the subscriber stations, weather conditions, and other factors. In an embodiment, the radius of the coverage areas of the base stations, for example, coverage areas 120 and 125 of base stations 102 and 103, may extend in the range from less than 2 kilometers to about fifty kilometers from the base stations.

As is well known in the art, a base station, such as base station 101, 102, or 103, may employ directional antennas to support a plurality of sectors within the coverage area. In FIG. 1, base stations 102 and 103 are depicted approximately in the center of coverage areas 120 and 125, respectively. In other embodiments, the use of directional antennas may locate the base station near the edge of the coverage area, for example, at the point of a cone-shaped or pear-shaped coverage area.

The connection to network 130 from base station 101 may comprise a broadband connection, for example, a fiber optic line, to servers located in a central office or another operating company point-of-presence. The servers may provide communication to an Internet gateway for internet protocol-based communications and to a public switched telephone network gateway for voice-based communications. In the case of voice-based communications in the form of voice-over-IP (VoIP), the traffic may be forwarded directly to the Internet gateway instead of the PSTN gateway. The servers, Internet gateway, and public switched telephone network gateway are not shown in FIG. 1A. In another embodiment, the connection to network 130 may be provided by different network nodes and equipment.

In accordance with an embodiment of the present disclosure, one or more of base stations 101-103 and/or one or more of subscriber stations 111-116 include a receiver that is operable to decode a plurality of data streams received as a combined data stream from a plurality of transmit antennas using an MMSE-SIC algorithm. As described in more detail below, the receiver is operable to determine a decoding order for the data streams based on a decoding prediction metric for each data stream that is calculated based on a strength-related characteristic of the data stream. Thus, in general, the receiver is able to decode the strongest data stream first, followed by the next strongest data stream, and so on. As a result, the decoding performance of the receiver is improved as compared to a receiver that decodes streams in a random or pre-determined order without being as complex as a receiver that searches all possible decoding orders to find the optimum order.

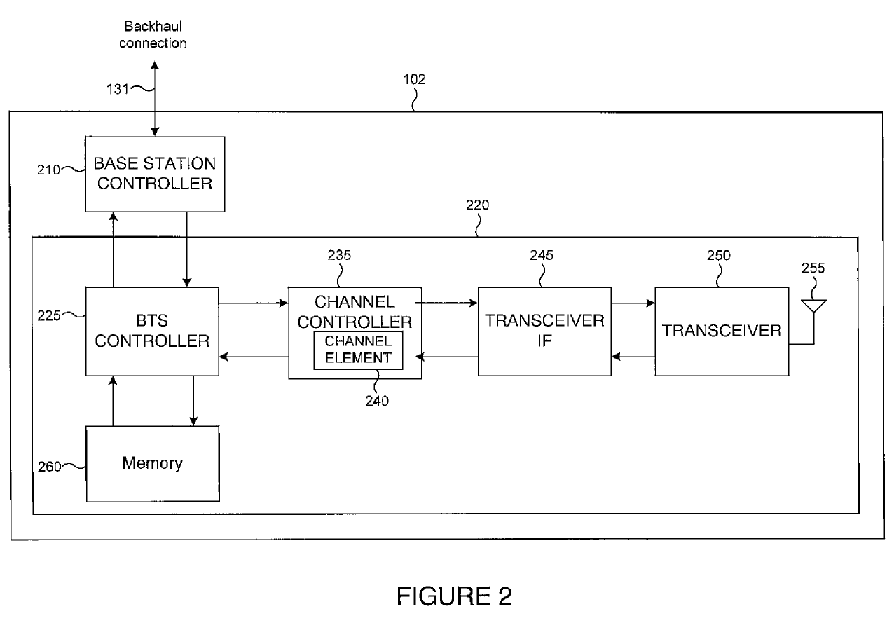

FIG. 2 illustrates an exemplary base station in greater detail according to one embodiment of the present disclosure. The embodiment of base station 102 illustrated in FIG. 2 is for illustration only. Other embodiments of the base station 102 could be used without departing from the scope of this disclosure.

Base station 102 comprises base station controller (BSC) 210 and base transceiver subsystem (BTS) 220. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present disclosure, the base transceiver subsystems in each of cells 121, 122 and 123 and the base station controller associated with each base transceiver subsystem are collectively represented by BS 101, BS 102 and BS 103, respectively.

BSC 210 manages the resources in cell site 121, including BTS 220. BTS 220 comprises BTS controller 225, channel controller 235, transceiver interface (IF) 245, RF transceiver unit 250, and antenna array 255. Channel controller 235 comprises a plurality of channel elements, including exemplary channel element 240. BTS 220 also comprises a memory 260. The embodiment memory 260 included within BTS 220 is for illustration only. Memory 260 can be located in other portions of BS 102 without departing from the scope of this disclosure.

BTS controller 225 comprises processing circuitry and memory capable of executing an operating program that communicates with BSC 210 and controls the overall operation of BTS 220. Under normal conditions, BTS controller 225 directs the operation of channel controller 235, which contains a number of channel elements, including channel element 240, that perform bi-directional communications in the forward channels and the reverse channels. A forward channel refers to a channel in which signals are transmitted from the base station to the mobile station (also referred to as DOWNLINK communications). A reverse channel refers to a channel in which signals are transmitted from the mobile station to the base station (also referred to as UPLINK communications). In an advantageous embodiment of the present disclosure, the channel elements communicate according to an OFDMA protocol with the mobile stations in cell 120. Transceiver IF 245 transfers the bi-directional channel signals between channel controller 240 and RF transceiver unit 250. The embodiment of RF transceiver unit 250 as a single device is for illustration only. RF transceiver unit 250 can separate transmitter and receiver devices without departing from the scope of this disclosure.

Antenna array 255 transmits forward channel signals received from RF transceiver unit 250 to mobile stations in the coverage area of BS 102. Antenna array 255 also sends to transceiver 250 reverse channel signals received from mobile stations in the coverage area of BS 102. In some embodiments of the present disclosure, antenna array 255 is a multi-sector antenna, such as a three-sector antenna in which each antenna sector is responsible for transmitting and receiving in a 120° arc of coverage area. Additionally, RF transceiver 250 may contain an antenna selection unit to select among different antennas in antenna array 255 during transmit and receive operations.

According to some embodiments of the present disclosure, BTS controller 225 is operable to execute programs, such as an operating system (OS) and processes for CoMP reporting and transparent resource mapping, stored in a memory 260. Memory 260 can be any computer readable medium, for example, the memory 260 can be any electronic, magnetic, electromagnetic, optical, electro-optical, electro-mechanical, and/or other physical device that can contain, store, communicate, propagate, or transmit a computer program, software, firmware, or data for use by the microprocessor or other computer-related system or method. Memory 260 comprises a random access memory (RAM) and another part of memory 260 comprises a Flash memory, which acts as a read-only memory (ROM).

BSC 210 is operable to maintain communications between BS 102 and BS 101 and BS 103. BS 102 communicates to BS 101 and BS 103 via the wireless connection 131. In some embodiments, the wireless connection 131 is wire-line connection.

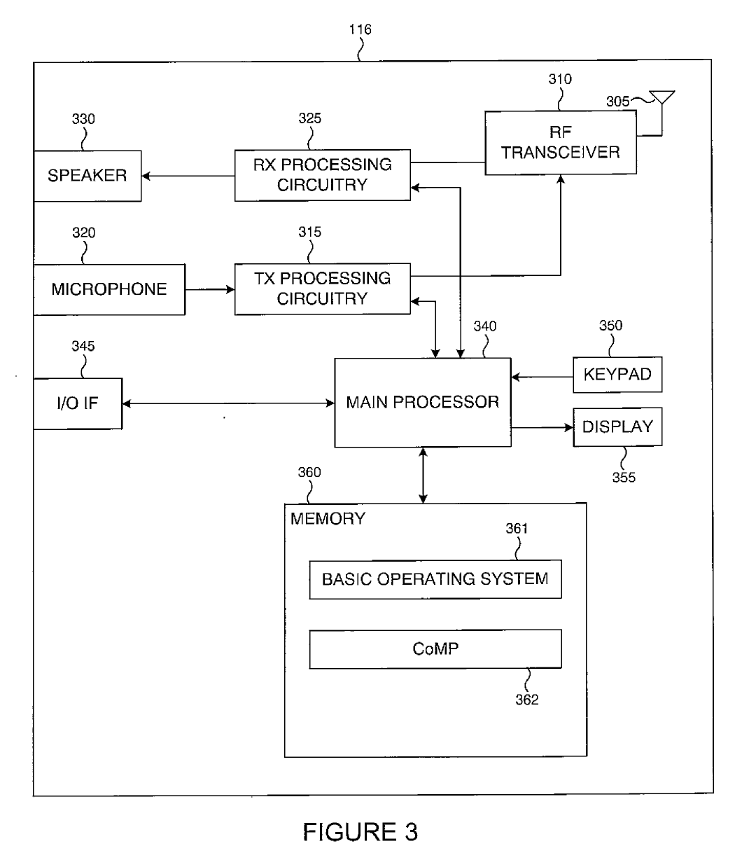

FIG. 3 illustrates an exemplary wireless subscriber station according to embodiments of the present disclosure. The embodiment of wireless subscriber station 116 illustrated in FIG. 3 is for illustration only. Other embodiments of the wireless subscriber station 116 could be used without departing from the scope of this disclosure.

Wireless subscriber station 116 comprises antenna 305, radio frequency (RF) transceiver 310, transmit (TX) processing circuitry 315, microphone 320, and receive (RX) processing circuitry 325. SS 116 also comprises speaker 330, main processor 340, input/output (I/O) interface (IF) 345, keypad 350, display 355, and memory 360. Memory 360 further comprises basic operating system (OS) program 361 and applications and/or instructions for CoMP operations 362.

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In some embodiments of the present disclosure, main processor 340 is a microprocessor or microcontroller. Memory 360 is coupled to main processor 340. According to some embodiments of the present disclosure, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless subscriber station 116. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360. Main processor 340 can move data into or out of memory 360, as required by an executing process. In some embodiments, the main processor 340 is configured execute programs, such as processes for CoMP operations 362. The main processor 340 can execute the CoMP operations 362 based on OS program 361 or in response to a signal received from BS 102. Main processor 340 is also coupled to I/O interface 345. I/O interface 345 provides subscriber station 116 with the ability to connect to other devices such as laptop computers and handheld computers. I/O interface 345 is the communication path between these accessories and main controller 340.

Main processor 340 is also coupled to keypad 350 and display unit 355. The operator of subscriber station 116 uses keypad 350 to enter data into subscriber station 116. Display 355 may be a liquid crystal display capable of rendering text and/or at least limited graphics from web sites. Alternate embodiments may use other types of displays.

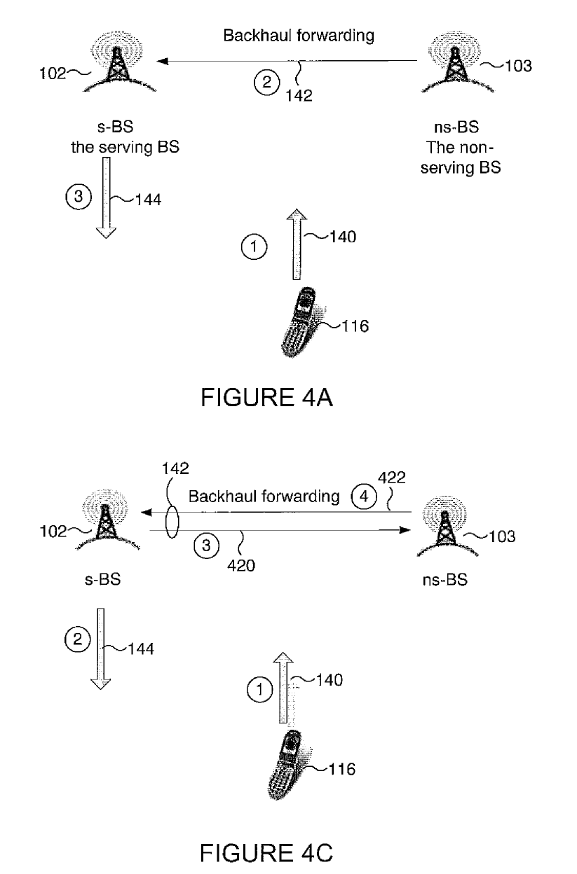

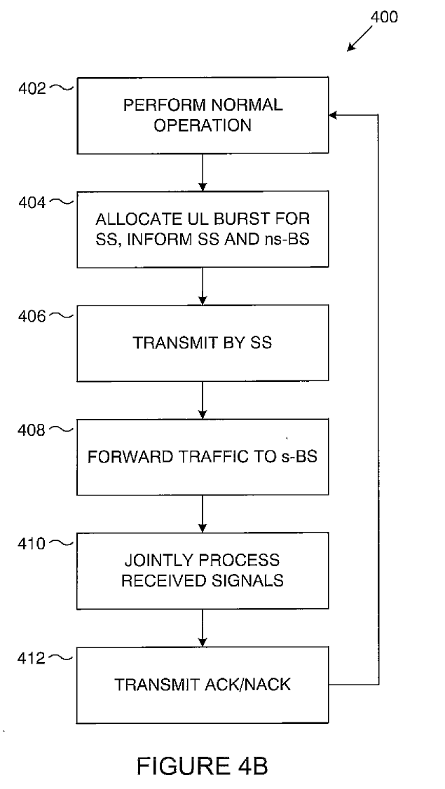

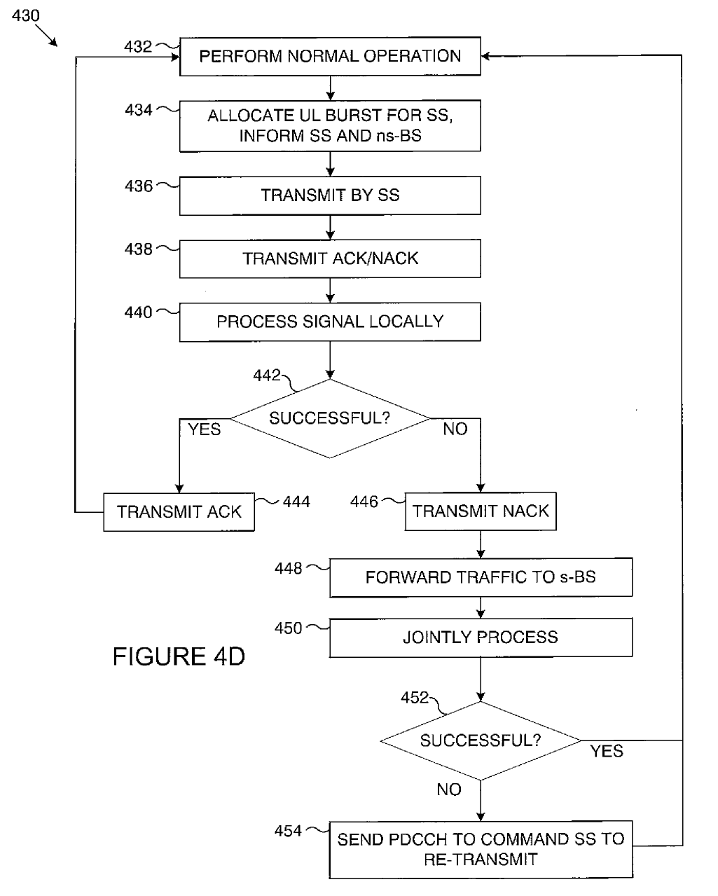

FIG. 4A illustrates an architecture of a CoMP operation according to the disclosure. s-BS 102 is the serving BS for SS 116 and ns-BS 103, which is the non-serving BS, is at least one other BS that provides support for the UL CoMP operation. First (indicated by the ‘1’ within the circle), SS 116 can transmit a data burst 140 to BS 102 as instructed by ns-BS 102. Prior to the data burst 140, s-BS 102 informed ns-BS 103 that the data burst 140 would occur. ns-BS 103 overhears the data burst 140 transmission and forwards the signal to s-BS 102 (indicated by the ‘2’ within the circle). ns-BS 103 can forward the signal via a backhaul connection 142 between s-BS 102 and ns-BS 103. s-BS 102 jointly processes the data burst 140 and the signal forwarded via the backhaul connection 142. s-BS 102 then transmits an acknowledgement (ACK)/negative acknowledgement (NACK) message 144 to SS 116 (indicated by the ‘3’ within the circle). The ACK/NACK message 144 indicates whether or not s-BS 102 successfully jointly decoded the data burst 140 and the signal forwarded via the backhaul connection 142. For example, the ACK/NACK message 144 includes an ACK when the joint decoding is successful.

FIG. 4B illustrates a process for a CoMP operation according to embodiments of the present disclosure. s-BS 102, ns-BS 103 and SS 116 perform normal operations in block 402. Each of the terminals, s-BS 102, ns-BS 103 and SS 116 (the CoMP UE) may have commenced normal operations at different times or one or more of the terminals may have commenced normal operations simultaneously. In block 404, s-BS 102 allocates an uplink (UL) burst for SS 116. s-BS 102 informs SS 116 and ns-BS 103, as an adjacent ns-BS, regarding the allocation. Thereafter, in block 406, SS 116 transmits a data burst according to the UL burst allocation from s-BS 102. ns-BS 103, aware of the UL burst allocation from s-BS 102 to SS 116, receives (e.g., overhears traffic from SS 116 to s-BS 102) the data burst from SS 116 and forwards the data burst (e.g., traffic) to s-BS 102 in block 408. ns-BS 103 can forward the traffic to s-BS 102 via the backhaul connection 142. s-BS 102 receives the data burst 140 from SS 116 and the forwarded traffic from ns-BS 103; and in block 410, s-BS 102 jointly process the signals (e.g., the data burst 140 from SS 116 and traffic from s-BS 103). In block 412, s-BS 102 transmits an ACK/NACK message 144 to SS 116. The ACK/NACK message 144 indicates whether or not s-BS 102 successfully jointly decoded the data burst 140 and the traffic forwarded from ns-BS 103. For example, the ACK/NACK message 144 includes an ACK when the joint decoding in block 410 is successful. Thereafter, s-BS 102, ns-BS 103 and SS 116 return to normal operation in block 402.

In the LTE-Advanced (LTE-A), UL CoMP should have very limited impact on the first Radio Access Network (RAN1) and second Radio Access Network (RAN2) specifications. However, an impact to RAN2 specifications may occur if the s-BS processing time of the combined reception is longer than 4 ms (which is the allowed propagation and processing time for LTE Rel-8 before sending the HARQ feedback to the UE).

In a first example, s-BS 102 will feedback the decoding results of first transmission to SS 116 prior to CoMP joint processing. After receiving a second transmission, the s-BS 102 can combine this signal with CoMP joint processing results. This is a typical HARQ scheme.

In a second example, s-BS 102 sends an ACK to SS 116 regardless of whether the decoding result is successful or unsuccessful. Upon receiving the ACK, SS 116 keeps the transmitted signal in a HARQ buffer, such as in memory 360, due to a scheme to support redundancy for a NACK→ACK error situation. s-BS 102 applies joint processing after receiving the signal forwarded from, an adjacent ns-BS, such as ns-BS 103, via the backhaul connection 142, and provides the final decoding results.

Compared to the first example, the second example could release a user's bandwidth to be scheduled to another user in the cell. Therefore the second example could have better spectral efficiency. Conversely, the first example could achieve better HARQ combining gain by providing more retransmission chances within a certain time. However, this gain maybe redundant since a user retransmits the signal before CoMP joint processing.

Using the second example, a new HARQ Round Trip Time (RTT) can be introduced for LTE-A. The RTT can be extended and a new value higher than 8ms can be defined in order to take into account the new latency requirements.

Additionally, using the second example, s-BS 102 sends the feedback corresponding to the local processing only before CoMP joint processing has occurred. After receiving the data from ns-BS 103, s-BS 102 generates a new feedback and acts accordingly.

Further, using the second example, s-BS 102 sends an ACK to SS 116 irrespective of whether the local decoding results is successful or unsuccessful. According to the existing rule in LTE, SS 116 maintains the data in the HARQ buffer. s-BS 102 performs the joint processing after receiving the signal forwarded from ns-BS 103 via the backhaul connection 142, and acts according to the new generated feedback.

FIG. 4C illustrates another architecture of a CoMP operation according to the disclosure. The architecture illustrated in FIG. 4C corresponds to the second example discussed above. First (indicated by the ‘1’ within the circle), SS 116 can transmit a data burst 140 to s-BS 102 as instructed by s-BS 102. Here, s-BS 102 sends the ACK/NACK message 144, which includes an ACK, to SS 116 before decoding the data (as indicated by the ‘2’ within the circle). Additionally, before ns-BS 103 forwards any signal to s-BS 102, s-BS 102 may transmit a second ACK/NACK message 420 to ns-BS 103 dependent on the local detection at ns-BS 103 (indicated by the ‘2’ within the circle). s-BS 102 can forward the second ACK/NACK message 420 via a backhaul connection 142 between s-BS 102 and ns-BS 103. ns-BS 103 overhears the data burst 140 transmission (e.g., traffic) and forwards the traffic 422 to s-BS 102 (indicated by the ‘4’ within the circle). ns-BS 103 can forward the signal via a backhaul connection 142 between s-BS 102 and ns-BS 103. Then, s-BS 102 jointly processes the data burst 140 and the traffic 422 forwarded via the backhaul connection 142.

FIG. 4D illustrates another process for a CoMP operation according to embodiments of the present disclosure. In block 432, s-BS 102, ns-BS 103 and SS 116 perform normal operations. Each of the terminals, s-BS 102, ns-BS 103 and SS 116 may have commenced normal operations at different times or one or more of the terminals may have commenced normal operations simultaneously.

In block 434, s-BS 102 allocates an uplink (UL) burst for SS 116. s-BS 102 informs SS 116 and ns-BS 103 regarding the allocation.

Thereafter, in block 436, SS 116 transmits a data burst according to the UL burst allocation from s-BS 102. s-BS 102, prior to performing a joint processing, transmits the ACK/NACK message 144 in block 438. The ACK/NACK message 144 can be an ACK that pretends to indicate that s-BS 102 successfully received the data burst 140 from SS 116. Thereafter, s-BS 102 locally processes the data burst 140 from SS 116 in block 440.

If the processing of the data burst 140 is successful in block 442, s-BS 102 transmits an ACK in the second ACK/NACK message 420 to ns-BS 103 in block 444. The second ACK/NACK message 420 can be transmitted via the backhaul connection 142. The ACK/NACK message 420 can indicate that s-BS 102 successfully decoded the data burst 140. Thereafter, s-BS 102, ns-BS 103 and SS 116 return to normal operation in block 432. Note that message 144 is different from message 420: the first is to SS, the second to a ns_BS.

If the processing is unsuccessful in block 442, s-BS 102 transmits a NACK in the second ACK/NACK message 420 to ns-BS 103 in block 446. The second ACK/NACK message 420 can be transmitted via the backhaul connection 142. The ACK/NACK message 420 indicates that s-BS 102 did not successfully decode the data burst 140.

BS 103, aware of the UL burst allocation from s-BS 102 to SS 116, receives (e.g., overhears traffic from SS 116 to BS 102) the data burst from SS 116. In response to receiving the NACK in block 446, ns-BS 103 forwards the data burst (e.g., traffic) to s-BS 102 in block 448. ns-BS 103 can forward the traffic 422 to s-BS 102 via the backhaul connection 142. s-BS 102 receives the forwarded traffic from ns-BS 103; and in block 450, s-BS 102 jointly process the signals (e.g., the data burst 140 from SS 116 and traffic from ns-BS 103) locally.

If s-BS 102 is unable to jointly decodes the data burst 140 and the traffic 422, that is the joint processing is unsuccessful in block 452, s-BS 102 sends, in block 454, a request for retransmission (e.g., a Packet Data Control Channel (PDCCH)) to command SS 116 to retransmit the data burst 140. If s-BS 102 successfully jointly decodes the data burst 140 and the traffic 422, that is, the joint processing is successful, s-BS 102, ns-BS 103 and SS 116 return to normal operation in block 432.

Embodiments of the present disclosure can provide a number of enhancements for UL CoMP operation in order to reduce the cost of backhaul communication among the BSs involved in the UL CoMP operation, and can increase system-wide spectrum efficiency.

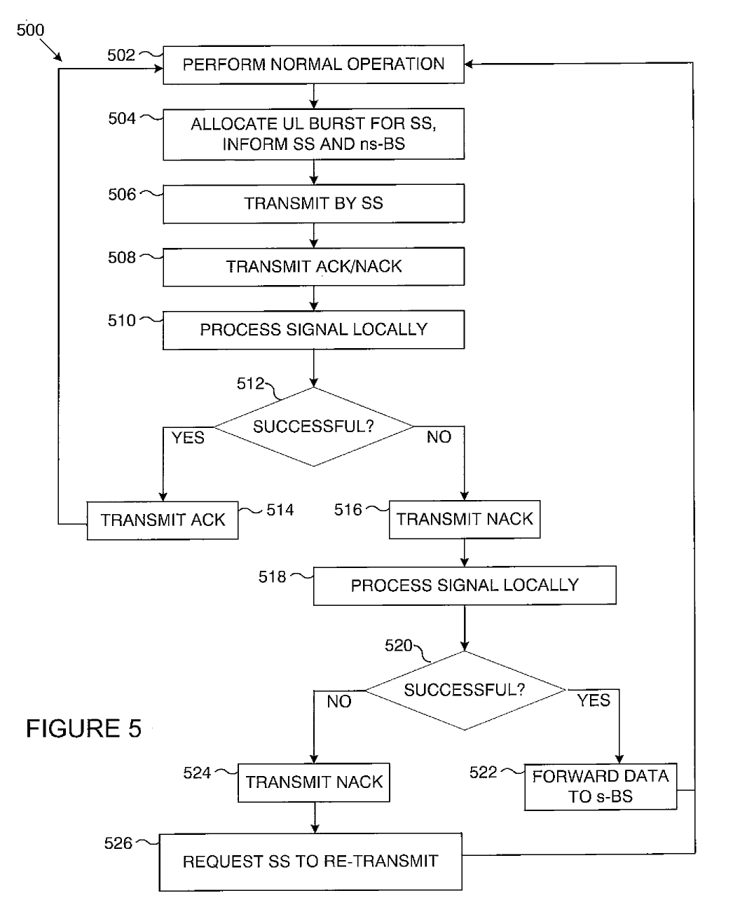

FIG. 5 illustrates a CoMP process with data only forwarding according to embodiments of the present disclosure. The embodiment of the CoMP process 500 shown in FIG. 5 is for illustration only. Other embodiments could be used without departing from the scope of this disclosure.

The s-BS sends an ACK to the SS irrespective of the local detection result in order to meet the HARQ timing requirement; but receives data forwarded by an ns-BS only if the local detection in the ns-BS succeeds, in order to reduce the backhaul bandwidth consumption. The operation completes if any of the BSs in the active set of the UL CoMP have successfully decoded the data. Otherwise, the s-BS may schedule the SS to re-transmit.

In block 502, s-BS 102, ns-BS 103 and SS 116 perform normal operations. In block 504, s-BS 102 allocates an uplink (UL) burst for SS 116. BS 102 informs SS 116 and ns-BS 103, as the adjacent ns-BS, regarding the allocation. Thereafter, in block 506, SS 116 transmits a data burst according to the UL burst allocation from s-BS 102. In block 508, s-BS 102 transmits the ACK/HACK message 144 prior to performing a joint processing. The ACK/NACK message 144 can be an ACK that pretends to indicate that s-BS 102 successfully received the data burst 140 from SS 116. Thereafter, s-BS 102 locally processes the data burst 140 from SS 116 in block 510. However, if the BS 102 can process local detection fast and the detection is successful, s-BS 102 can indeed ACK the ns-BS 103 in which case there is no need for further processing including the joint detection.

If it is determined that the processing of the data burst 140 is successful in block 512, s-BS 102 transmits an ACK, such as in the second ACK/NACK message 420, to ns-BS 103 in block 514. The ACK can be transmitted via the backhaul connection 142. The ACK indicates that s-BS 102 successfully decoded the data burst 140. Thereafter, s-BS 102, ns-BS 103 and SS 116 return to normal operation in block 502.

If it is determined that the processing is unsuccessful in block 512, s-BS 102 transmits a NACK, such as in the second ACK/NACK message 420, to ns-BS 103 in block 516. The NACK can be transmitted via the backhaul connection 142. The NACK indicates that s-BS 102 did not successfully decode the data burst 140. In some embodiments, the second ACK/NACK message 420 is optional. For example, ns-BS 103 may interpret a NACK from the s-BS 102 if an ACK is not received.

Aware of the UL burst allocation from s-BS 102 to SS 116, ns-BS 103 overhears signals, such as traffic 422 from SS 116 to s-BS 102 (that is also the data burst 140 from SS 116). In block 518, ns-BS 103 processes the signal locally.

If it is determined that the processing is successful in block 520, ns-BS 103 forwards the signals to s-BS 102 via the backhaul connection 142 in block 522. In some embodiments, ns-BS 103 sends an ACK to s-BS 102 first, and then sends data. For example, s-BS 102 can receive an ACK and/or the decoded data from at least one ns-BS (i.e., ns-BS 103 and/or ns-BS 101) that has successfully decoded the received data.

If it is determined that the processing is unsuccessful in block 520, ns-BS 103 transmits a NACK, such as in a third ACK/NACK message, to s-BS 102 in block 524. In response to receiving the third NACK, s-BS 102 requests SS 116 to re-transmit the data burst 140 in block 526. For example, s-BS 102 can send a PDCCH to command SS 116 to retransmit the data burst 140. s-BS 102 can request SS 116 for a re-transmission if the maximum number of re-transmission has not been reached. Thereafter, s-BS 102, ns-BS 103 and SS 116 return to normal operation in block 502.

In the CoMP process 500 shown in FIG. 5, joint processing in the s-BS is not necessary because an ns-BS only forwards the data if the data is successfully decoded. For example, if one s-BS and two ns-BSs exist in the active set and the first HARQ transmission can pass through with the probability of 70% in each BS, the first transmission will fail only if all the three BSs fail to decode the data, which is a probability of 0.27%. This implies 10⁻³ Layer-1 PER in the first transmission.

In some embodiments, the s-BS sends a NACK to one or more ns-BSs if the local detection in the s-BS fails such that the ns-BS can forward the data to the s-BS immediately. Alternatively, the s-BS does not send anything to the ns-BSs if local detection fails, in which case the ns-BS implicitly determines the local detection failure, such as by maintaining a certain timer that is started as soon as receiving the signal (data burst 140) from the SS. Accordingly, the ns-BS can determine that the local detection in the s-Bs fails if no ACK is received from the s-BS upon the timer expires.

The SS signal (data burst 140 from SS 116) may be so weak that an ns-BS could not even detect it. However, all the ns-BSs can be informed by the s-BS about the scheduling of the SS UL transmission timing. Therefore, the timer could also be started at the time the SS is scheduled for transmission. This same principle can also be applied for all other timer embodiments of the present disclosure.

In additional embodiments, an ns-BS can forward data to the s-BS directly if the local processing at the ns-BS is successful. In other words, an ns-BS does not have to wait for the ACK or NACK from the s-BS. Therefore, the overall processing time can be shortened, especially for the case of long delay in the backhaul between the s-BS and ns-BS. In yet another embodiment, the ns-BS can send an ACK message to the s-BS before the forwarding of the entire data burst if it takes longer time for forwarding the data.

In some embodiments, the ns-BS can send a NACK to the s-BS if the local detection in the ns-BS fails, such that the s-BS does not have to wait unnecessarily. The s-BS can maintain a timer that is started upon receiving the data burst signal from the SS. The s-BS stops waiting for data forwarding from the ns-BSs when the timer expires.

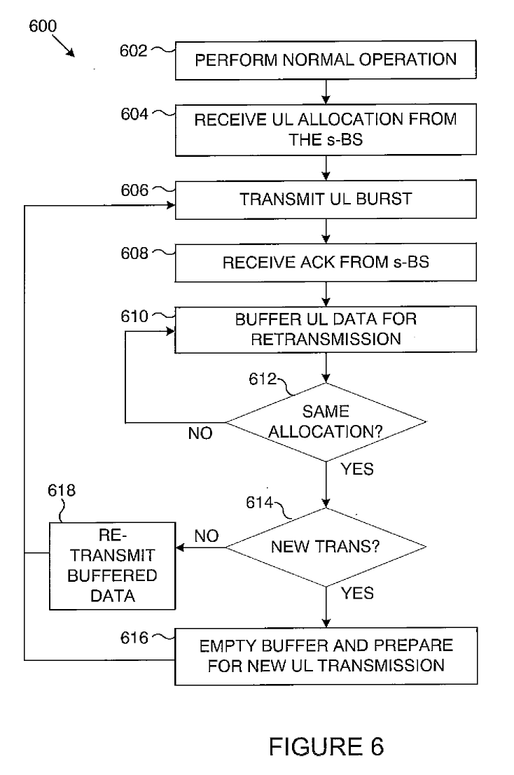

FIG. 6 illustrates a CoMP process in the SS according to embodiments of the present disclosure. The embodiment of the CoMP process 600 shown in FIG. 6 is for illustration only. Other embodiments could be used without departing from the scope of this disclosure.

In block 602, s-BS 102, ns-BS 103 and SS 116 perform normal operations. In block 604, SS 116 receives the UL burst allocation from s-BS 102; and transmits a data burst according to the UL burst allocation from s-BS 102 in block 606. SS 116 receives the ACK/NACK message 144 from s-BS 102 in block 608. In block 610, SS 116 buffers the UL data for retransmission. In block 612, SS 116 then determines if a second UL burst allocation has been received from s-BS 102. If it is determined that the second UL burst allocation for the same HARQ process has not been received in block 612, SS 116 returns to block 610. If the second UL burst allocation is received in block 612, in block 614 SS 116 determines if the second UL burst allocation is for the same transmission that was previously sent or for a new transmission. If the second UL burst allocation is for a new transmission, SS 116 empties the buffer and prepares for the new UL transmission in block 616. If the second UL burst allocation is not for a new transmission, that is, the second UL burst allocation is for a retransmission of the previous transmission, SS 116 re-transmits the buffered data in block 618. Thereafter, SS 116 returns to block 606 to transmit the data burst.

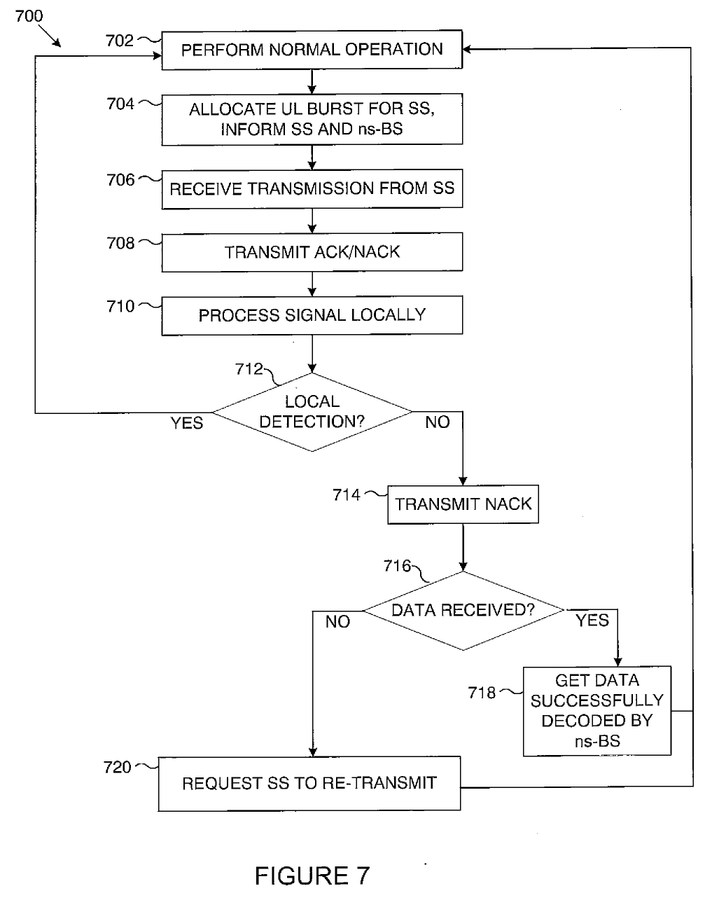

FIGS. 7 through 9 illustrate the CoMP process in the s-BS according to embodiments of the present disclosure. The embodiments of the CoMP processes shown in FIGS. 7 through 9 are for illustration only. Other embodiments could be used without departing from the scope of this disclosure.

In block 702, s-BS 102, ns-BS 103 and SS 116 perform normal operations. In block 704, s-BS 102 allocates an uplink (UL) burst for SS 116. Additionally, s-BS 102 informs SS 116 and ns-BS 103, as the adjacent ns-BS, regarding the allocation. Thereafter, in block 706, s-BS 102 receives a data burst transmission from SS 116. Prior to performing a joint processing, s-BS 102 transmits the ACK/NACK message 144 in block 708. The ACK/NACK message 144 can be an ACK that indicates that BS 102 successfully received the data burst 140 from SS 116. For example, if the BS 102 detection is successful, s-BS 102 ACKs the ns-BS 103. Thereafter, s-BS 102 locally processes the data burst 140 from SS 116 in block 710.

In the CoMP process 700 in FIG. 7, if it is determined that the processing of the data burst 140 is successful in block 712 (e.g., local detection at the s-BS is successful), s-BS 102, ns-BS 103 and SS 116 return to normal operation in block 702. If it is determined that the processing is unsuccessful in block 712, s-BS 102 transmits a NACK, such as in the second ACK/NACK message 420, to ns-BS 103 in block 714. The NACK can be transmitted via the backhaul connection 142. The NACK indicates that s-BS 102 did not successfully decode the data burst 140. In block 716, s-BS 102 determines if data is received from ns-BS 103 (or ns-BS 101—an additional ns-BS). If s-BS 102 receives data in block 716 and successfully decodes the data in block 718, then s-BS 102, ns-BS 103 and SS 116 return to normal operation in block 702. If s-BS 102 does not receive data in block 716, s-BS 102 sends a request to SS 116 to retransmit the data burst 140 in block 720; then s-BS 102, ns-BS 103 and SS 116 return to normal operation in block 702.

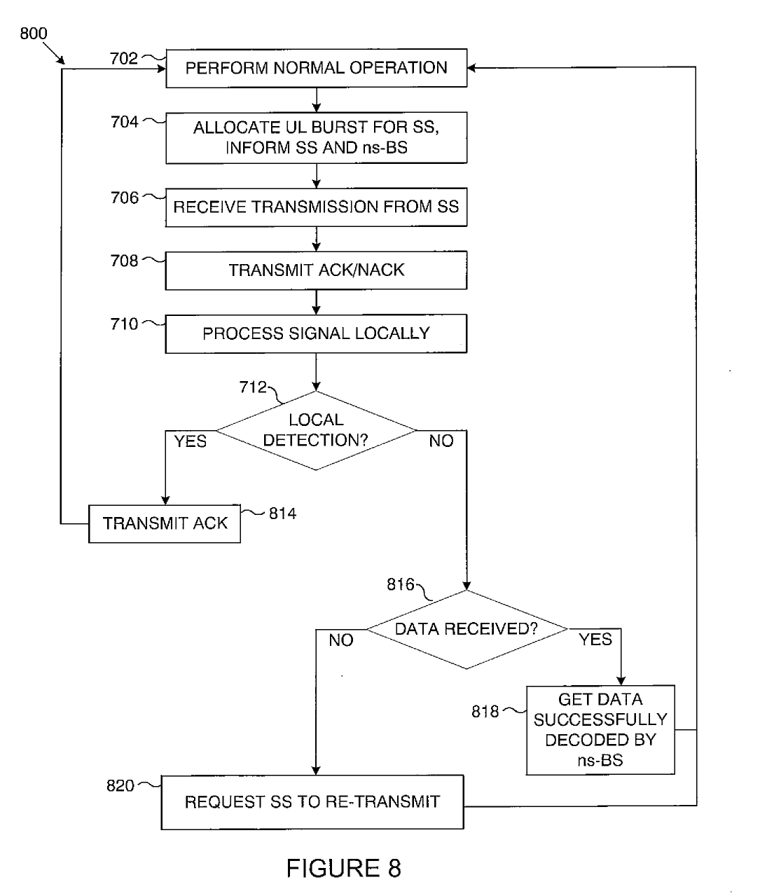

In the CoMP process 800 in FIG. 8, if it is determined that the processing of the data burst 140 is successful in block 712, s-BS 102 transmits an ACK, such as in the second ACK/NACK message 420, to ns-BS 103 in block 814. The ACK can be transmitted via the backhaul connection 142. Then, s-BS 102, ns-BS 103 and SS 116 return to normal operation in block 702. If it is determined that the processing is unsuccessful in block 712, s-BS 102 determines, in block 816, if data is received from ns-BS 103 (or BS 101—an additional ns-BS). If s-BS 102 receives data in block 816 and successfully decodes the data in block 818, then s-BS 102, ns-BS 103 and SS 116 return to normal operation in block 702. If s-BS 102 does not receive data in block 816, s-BS 102 sends a request to SS 116 to retransmit the data burst 140 in block 820; then s-BS 102, ns-BS 103 and SS 116 return to normal operation in block 702.

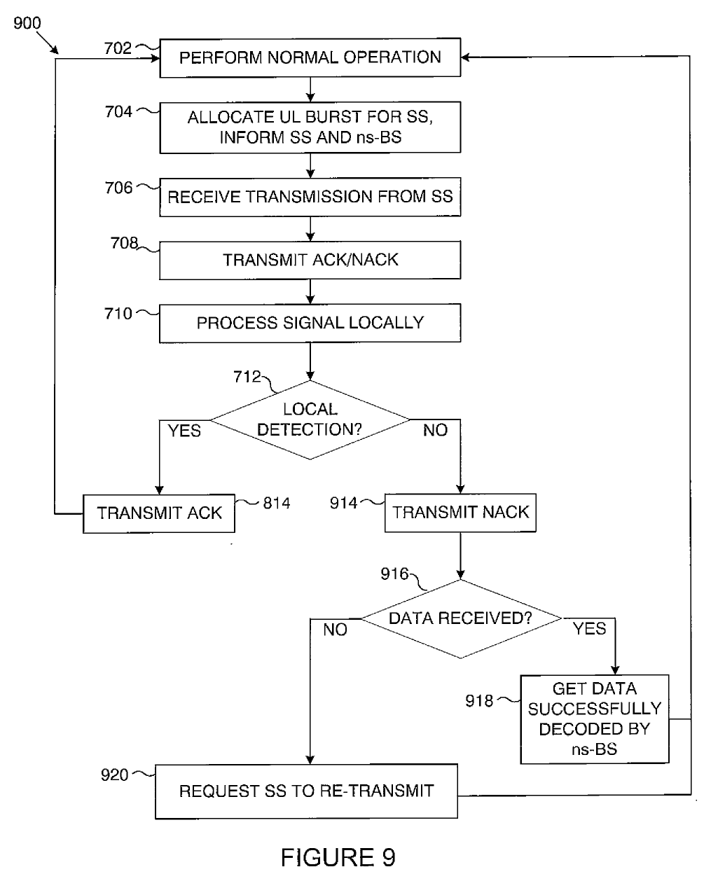

In the CoMP process 900 in FIG. 9, if it is determined that the processing of the data burst 140 is successful in block 712, s-BS 102 transmits an ACK, such as in the second ACK/NACK message 420, to ns-BS 103 in block 814. The ACK can be transmitted via the backhaul connection 142. Then, s-BS 102, ns-BS 103 and SS 116 return to normal operation in block 702. If it is determined that the processing is unsuccessful in block 712, s-BS 102 transmits a NACK, such as in the second ACK/NACK message 420, to ns-BS 103 in block 714. The NACK indicates that BS 102 did not successfully decode the data burst 140. In block 916, s-BS 102 determines if data is received from ns-BS 103 (or ns-BS 101—an additional ns-BS). If s-BS 102 receives data in block 916 and successfully decodes the data in block 918, then s-BS 102, ns-BS 103 and SS 116 return to normal operation in block 702. If s-BS 102 does not receive data in block 916, s-BS 102 sends a request to SS 116 to retransmit the data burst 140 in block 920; then s-BS 102, ns-BS 103 and SS 116 return to normal operation in block 702.

The difference is what message the s-BS sends to the ns-BSs after the local detection in the s-BS. In FIG. 7, the s-BS sends nothing to the ns-BSs if local detection is successful, and sends a NACK message to the ns-BSs if the local detection at the s-BS fails. In this case, each ns-BS treats the lack of the NACK message as an ACK from the s-BS. Similarly, FIG. 8 shows the ACK-based alternative where the s-BS sends an ACK only if the local detection succeeds and the ns-BS treats the lack of ACK message as a NACK from the s-BS. In some embodiments, shown in FIG. 9, the s-BS sends either the ACK or NACK explicitly dependent on the local detection results in the s-BS. As such, the s-BS sends a message if needed as soon as the local detection completes, and the ns-BS can maintain a certain timer such that the ns-BS knows when to stop waiting for a message from the s-BS.

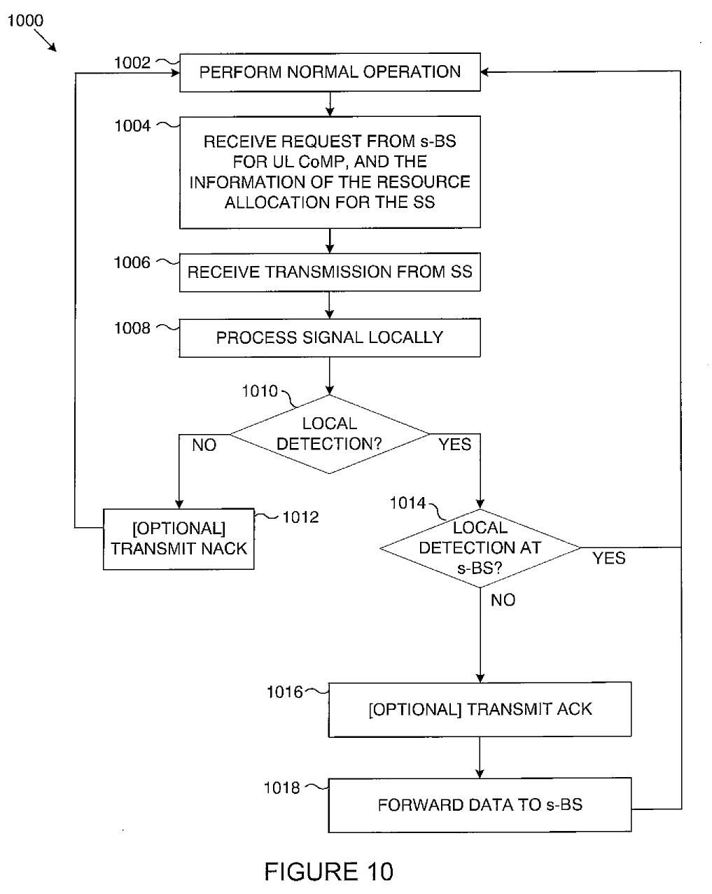

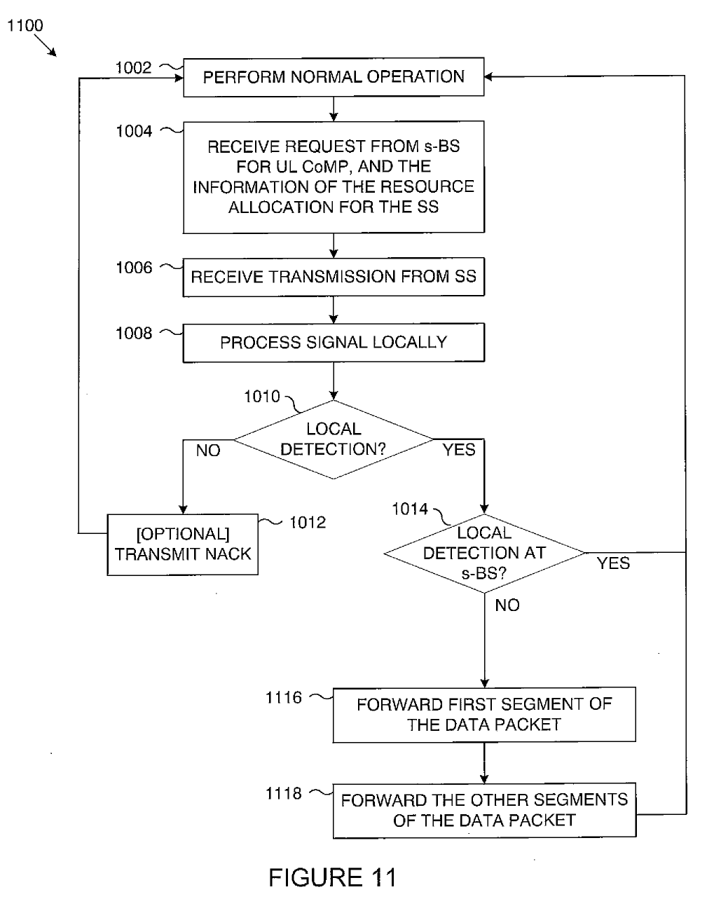

FIGS. 10 and 11 illustrate the CoMP process in the ns-BS according to embodiments of the present disclosure. The embodiments of the CoMP processes shown in FIGS. 10 and 11 are for illustration only. Other embodiments could be used without departing from the scope of this disclosure.

In block 1002, s-BS 102, ns-BS 103 and SS 116 perform normal operations. In block 1004, ns-BS 103 receives a request from s-BS 102 for the UL CoMP. Additionally, ns-BS 103 receives information regarding the resource allocation for an UL burst for SS 116. Thereafter, ns-BS 103 receives (overhears) the data burst 140 (e.g., traffic 422) signals from SS 116 in block 1006. In block 1008, ns-BS 103 locally processes the data burst 140 signals from SS 116. In block 1010, ns-BS 103 determines if the local detection (e.g., the local processing of the signals in block 1008) is successful.

If it is determined that the processing of the data burst 140 is unsuccessful in block 1010 (e.g., local detection at the ns-BS not successful), ns-BS 103 transmits a NACK in block 1012. In some embodiments, the transmission of the NACK in block 1012 is optional. Thereafter, s-BS 102, ns-BS 103 and SS 116 return to normal operation in block 1002. If it is determined that the processing of the data burst 140 is successful in block 1010 (e.g., local detection at the ns-BS is successful), ns-BS 103 determines if local detection at s-BS 102 (the s-BS) is successful in block 1014. If it is determined that the local detection at s-BS 102 is successful in block 1014, s-BS 102, ns-BS 103 and SS 116 return to normal operation in block 1002.

In the CoMP process 1000 in FIG. 10, if it is determined that the local detection at s-BS 102 is unsuccessful in block 1014, ns-BS 103 transmits a short ACK message to s-BS 102 in block 1016. The short ACK message can be transmitted via the backhaul connection 142. In block 1018, ns-BS 103 forwards the data to s-BS 102. Thereafter, BS 102, BS 103 and SS 116 return to normal operation in block 1002.

In the operations of the ns-BS illustrated in FIGS. 10 and 11, the determination of the success of the local detection at the s-BS operates differently based on the negotiation with the s-BS about which process, such as CoMP process 700 in FIG. 7, CoMP process 800 in FIG. 8 and CoMP process 900 in FIG. 9 is used. The difference between FIG. 10 and FIG. 11 occurs right after local detection 1014, where instead of sending a short ACK message to s-BS 102 in block 1016, ns-BS 103 may partition the data packet if it cannot be carried in one data packet and piggyback an ACK field in the first segment to s-BS 102 in block 1116. ns-BS 103 also forwards the other segments of the data packet to s-BS 102 in block 1118.

In some embodiments, a low-overhead CoMP solution is provided when there are multiple ns-BSs in the active set. A BS multicasts an indicator message (noted as “Yes!” message in the sequel) to other BSs in the active set if the local detection in this BS is successful. Each BS also maintains a timer (noted as T_CoMP) that is started upon receiving the MS transmission. The T_CoMP Timer can be long enough such that a “Yes!” message, if sent by any BS after local detection, can reach other BSs before the timer expires. The T_CoMP Timer also is short enough to avoid unnecessary waiting at other BSs. This provides a contention and resolution mechanism for any BS to inform all other BSs about the local detection result. The “Yes!” message is a very short message, which may be just a dummy message because the existence of itself already informs the other BSs in the active set that the local detection of the message transmitter succeeds. No matter on what network layer (e.g., an IP packet) the message is transmitted, the essential information field is the identity of the message transmitter.

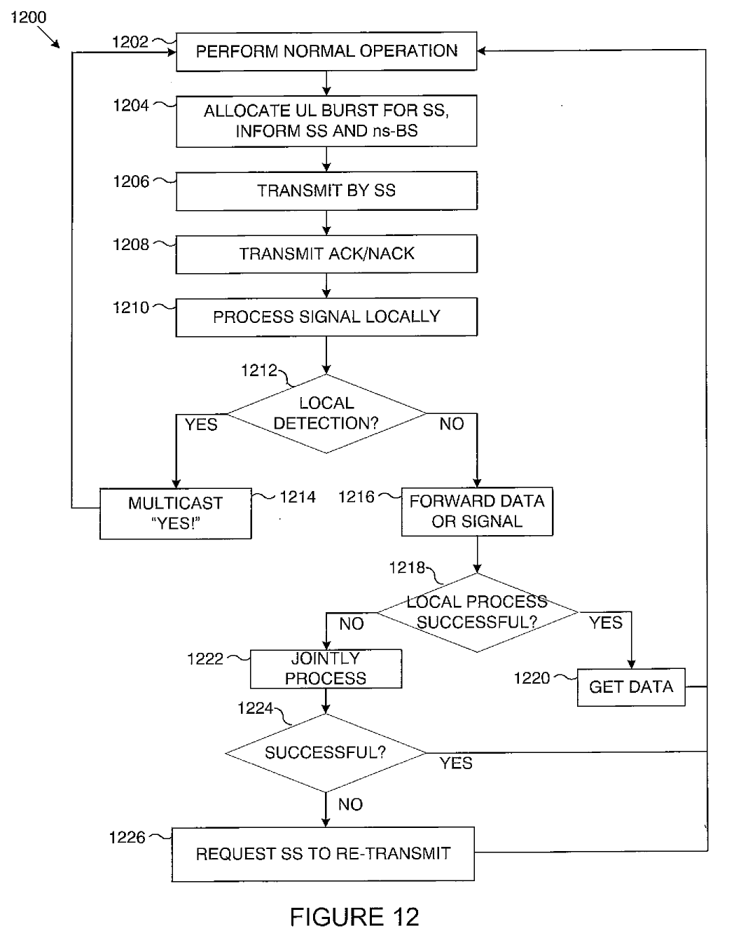

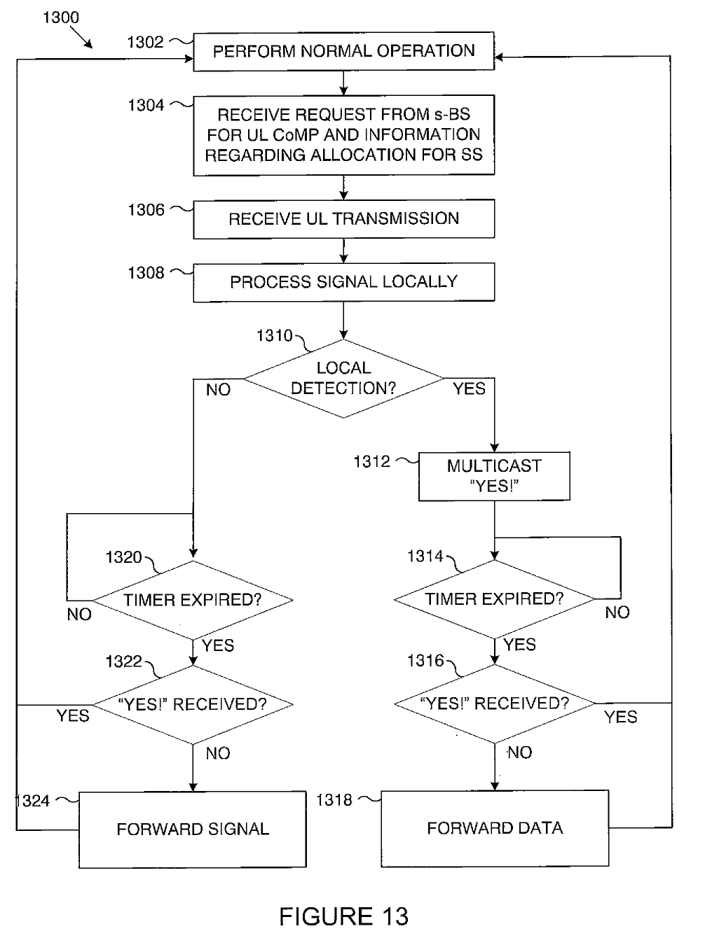

FIGS. 12 and 13 illustrate CoMP operations for the s-BS and ns-BS according to embodiments of the present disclosure. The embodiments shown in FIGS. 12 and 13 are for illustration and other embodiments could be used without departing from the scope of this disclosure.

FIG. 12 illustrates operations in the s-BS, such as BS 102. In block 1202, s-BS 102, ns-BS 103 and SS 116 perform normal operations. In block 1204, s-BS 102 allocates an uplink (UL) burst for SS 116. s-BS 102 informs SS 116, ns-BS 103 and ns-BS 101, the adjacent ns-BSs, regarding the allocation. Thereafter, in block 1206, SS 116 transmits a data burst according to the UL burst allocation from s-BS 102. Prior to performing a joint processing, s-BS 102 transmits an ACK message in block 1208. The ACK can pretend to indicate that BS 102 successfully received the data burst 140 from SS 116. For example, if the s-BS 102 detection is successful, s-BS 102 transmits the ACK to one or more of ns-BS 103, ns-BS 101 or SS 116. Thereafter, s-BS 102 locally processes the data burst 140 from SS 116 in block 1210.

If it is determined that the processing of the data burst 140 is successful in block 1212, s-BS 102 multicasts an ACK to ns-BS 103 and ns-BS 101 in block 1214. The ACK multicast indicates that BS 102 successfully decoded the data burst 140. Thereafter, s-BS 102, ns-BS 103 and SS 116 return to normal operation in block 1202.

If it is determined that the processing is unsuccessful in block 1212, ns-BS 103 and ns-BS 101 forward data (traffic or signals) to s-BS 102 in block 1216. Thereafter, in block 1218, it is determined if the local process in any ns-BS (ns-BS 103 or ns-BS 101) is successful.

If it is determined that the local processing is successful in block 1218, ns-BS 103 and/or ns-BS 101 forward the decoded data to s-BS 102 in block 1220. Thereafter, s-BS 102, ns-BS 103 and SS 116 return to normal operation in block 1202.

If it is determined that the local processing is unsuccessful in block 1218, s-BS 102 jointly decodes the data, using the data burst from SS 116 and the forwarded data from ns-BS 103 and/or ns-BS 101 forward data in block 1222. If it is determined that s-BS 102 successfully jointly decoded the data in block 1224, s-BS 102, ns-BS 103 and SS 116 return to normal operation in block 1202.

If it is determined that s-BS 102 was unable to successfully jointly decode the data in block 1224, in block 1226, s-BS 102 sends a request to SS 116 to retransmit the data burst if the maximum number of retransmission has not reached. Thereafter, s-BS 102, ns-BS 103 and SS 116 return to normal operation in block 1202.

FIG. 13 illustrates operations in the ns-BS, such as ns-BS 103 (or ns-BS 101). In block 1302, s-BS 102, ns-BS 103 and SS 116 perform normal operations. In block 1304, ns-BS 103 receives the uplink (UL) burst allocation for SS 116. Thereafter, in block 1306, s-BS 103 receives the data burst transmission from SS 116. ns-BS 103 starts the T_CoMP Timer as soon as the UL data is received from SS 116.

In block 1308, ns-BS 103 performs local detection. ns-BS 103 process the UL data signal locally. If it is determined that the local detection is successful in block 1310, a “Yes!” message is multicast in block 1312 to other BSs in the active set. In block 1314, it is determined if the T_CoMP timer has expired. When the T_CoMP timer expires in block 1314, it is determined if the “Yes!” message has also been received from s-BS 102. If the “YES!” message has been received from s-BS 102 in block 1314, s-BS 102, ns-BS 103 and SS 116 return to normal operation in block 1302. Alternatively, if local detection at the s-BS 102 is unsuccessful, ns-BS 103 forwards the data to s-BS 102 as indicated in block 1318. Thereafter, ns-BS 103 returns to normal operation in block 1302.

Alternatively, if it is determined that the local detection at an ns-BS is unsuccessful in block 1310; and when the T_CoMP timer expires in block 1320, it is determined if the “Yes!” message has been received from another BS in block 1322. If the message has been received in block 1322, ns-BS 103 returns to normal operation in block 1302. Alternatively, if the message has not been received in block 1322, ns-BS 103 forwards analog or semi-analog data to s-BS 102 in block 1324. Thereafter, ns-BS 103 returns to normal operation in block 1302.

In some embodiments, if multiple ns-BSs (e.g., both ns-BS 103 and ns-BS 101) have successfully decoded data, only one ns-BS (e.g., ns-BS 103 or ns-BS 101) forwards the data to the s-BS 102, using an explicit rule or implicit decision-making rules, such as, the ns-BS with the lowest Cell-ID, BS-ID, or other non-ambiguous parameters. In which case, the procedure in ns-BS could be modified as follows. If the “Yes!” message is not received in block 1322, it is determined if the ns-BS 103 is supposed to forward data to s-BS 102 according to the predetermined rule. If so, ns-BS 103 forwards the signal in block 1324. If not, ns-BS 103 returns to normal operation in block 1302.

In some embodiments, only one of the ns-BS that have successfully decoded data locally will forward data to the s-BS if the local detection in the s-BS fails. Similar to the CoMP process 500, only decoded data will be forwarded to the s-BS. Similar to the CoMP process 1200, all the BSs that have successfully decoded the data locally shall inform other BSs in the active set, and only one ns-BS shall forward the data to the s-BS if necessary.

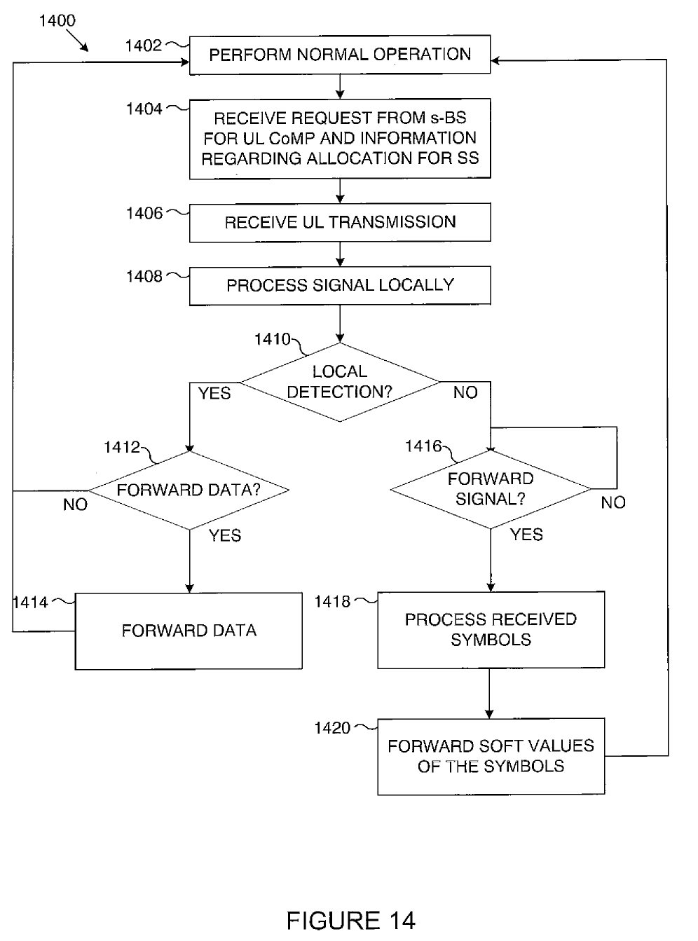

A further enhancement to the CoMP process 1200 is, when the local detection in all the BSs in the active set fail, the ns-BS will forward the processed signal, rather than the raw symbol to the s-BS which could occupy large backhaul resource. One option is for those ns-BSs to forward the soft values of the received modulation symbols (possibly compensated by channel estimates already). Also, an ns-BS does not need to feedback the soft bits for the whole band. The ns-BS only feedbacks the soft values on those resources where the packet of interest is transmitted. Another option is for the ns-BS to forward the Log-likelihood Ratio (LLR) soft values of the coded bits. This embodiment is illustrated in the CoMP process 1400 shown in FIG. 14. In this embodiment, the s-BS and the ns-BSs can agree in advance regarding what kinds of soft values the ns-BS forwards.

In block 1402, s-BS 102, ns-BS 103 and SS 116 perform normal operations. In block 1404, ns-BS 103 receives the uplink (UL) burst allocation for SS 116. Thereafter, in block 1406, ns-BS 103 receives the data burst transmission from SS 116. In block 1408, ns-BS 103 performs local detection. ns-BS 103 process the UL data signal locally.

If it is determined that the local detection is not successful in block 1410, ns-BS 103 determines, in block 1416, whether it should forward the signal to s-BS 102. If ns-BS 103 determines that it should not forward the signal to s-BS 102, ns-BS 102 returns to normal operation in block 1402. Alternatively, ns-BS 103 processes the received symbols in block 1418. Then, ns-BS 103 forwards the soft values of the symbols to s-BS 102 in block 1420. Thereafter, ns-BS 103 returns to normal operation in block 1402.

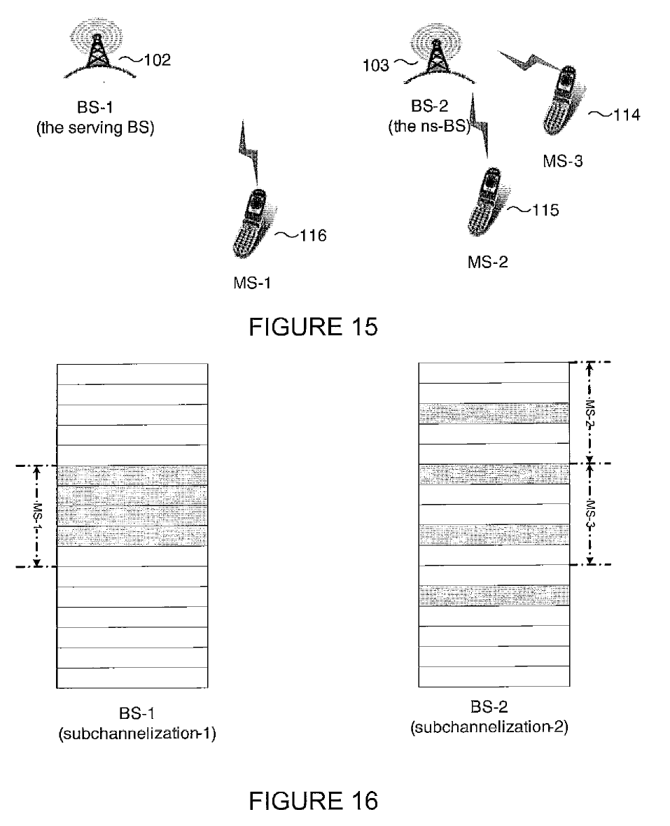

In the CoMP process 1400, BS 103 (an ns-BS) can schedule its own SS (e.g., SS 115) to transmit while the ns-BS is cooperating with s-BS 102 for the UL CoMP operation for SS 116 as illustrated in FIG. 15. Both SS 115 and SS 116 can use overlapped radio resources. Both ns-BS 102 and ns-BS 103 can use the same subchannelization scheme. Alternatively, ns-BS 102 and ns-BS 103 can use different subchannelization schemes as illustrated in FIG. 16. In FIG. 16, the shaded subcarriers in the left column are assigned by the s-BS 102 to SS 116 in the CoMP operation. The s-BS 102 informs ns-BS 103 about the CoMP resource allocation, thus, ns-BS 103 knows which subcarriers (e.g., the shaded subcarriers in the right column) that are interested in by s-BS 102.

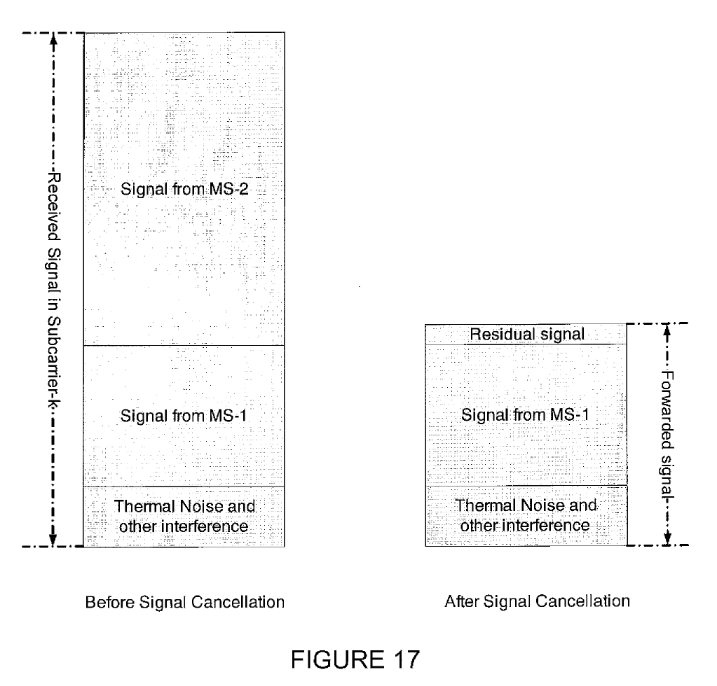

FIG. 17 illustrates the signal cancellation and forwarding operation for a subcarrier in the ns-BS according to embodiments of the present disclosure. In FIG. 17, the residual signal may or may not exist dependent on how successful the signal cancellation is.

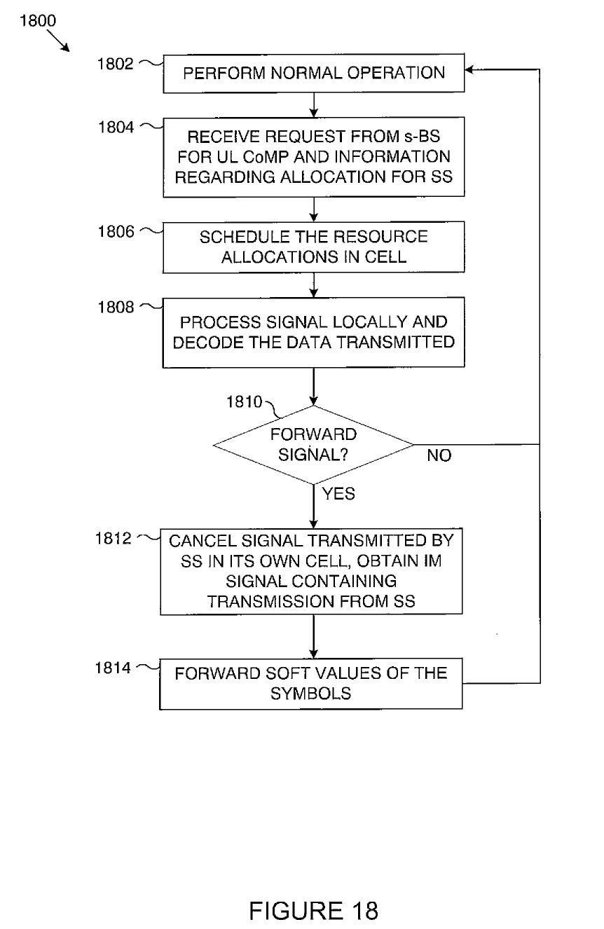

FIG. 18 illustrates a cancellation procedure in the ns-BS according to embodiments of the present disclosure. The embodiment of the cancellation procedure 1800 shown in FIG. 18 is for illustration only. Other embodiments could be used without departing from the scope of this disclosure.

In block 1802, ns-BS 103, s-BS 102 and SS 116 perform normal operation. s-BS 102 schedules band-x (e.g., a physical resource block (PRB) for SS 116. s-BS 102 requests ns-BS 103 to forward band-x signal to s-BS 102. In block 1804, ns-BS 103 receives a request from s-BS 102 for UL CoMP, and the information regarding the resource allocation for SS 116. In block 1806, ns-BS 103 schedules the resource allocation in its own cell. In block 1808, ns-BS 103 locally processes the signal and decodes the data transmitted by the subscriber stations in its own cell first. In block 1810, ns-BS 103 determines whether it should forward the signal to s-BS 102 or not. If ns-BS 103 determines, in block 1810, that it should not forward the signal to s-BS 103, ns-BS 103 returns to normal operation in block 1802. If ns-BS 103 determines, in block 1810, that it should forward the signal to s-BS 103, ns-BS 103 cancels the signal transmitted by the subscriber station in its own cell, obtains the IM signal that contains the transmission from SS 116 in block 1812. ns-BS 103 completes decoding of the signal in its own cell, cancels the signal transmitted by the subscriber stations in its own cell, and obtains the interference and noise (IN).

Then, in block 1814, ns-BS 103 forwards the soft values of the symbols to the s-BS 103. Optionally, ns-BS 103 tries to decode SS 116 data from the IN. If the detection is successful, ns-BS 103 forwards the data to s-BS 102. Otherwise, ns-BS 103 forwards IN of band-x to s-BS 102. Thereafter, s-BS 102 combines the signal from its own cell and the IN forwarded by ns-BS 103. s-BS 102 decodes band-x for data sent by SS 116.

It will be understood that these embodiments are not limited to only one ns-BS. There could be multiple ns-BSs that perform signal cancellation in their own cells, and forward the IN to the s-BS. Optionally, each of those ns-BSs could try to decode MS-1 data locally after cancelling the signals from their own MSs. Note that these embodiments could be combined with previous embodiments such that the forwarding can be triggered by a request from the s-BS. For example, ns-BS 103 only forwards if s-BS 102 fails decoding. Different signaling flows can be designed, resulting in different tradeoff of delay vs. backhaul overhead.

Embodiments of this disclosure provide several ways for reducing the backhaul bandwidth occupation, e.g., data forwarding only as in CoMP process 500, only one ns-BS to forward data or signal to the s-BS as in CoMP process 1200, and the forwarding of soft values or LLR as in CoMP process 1400. Embodiments extend the CoMP operation to the case with multiple ns-BSs while maintaining low backhaul occupation among the BSs in the active set. Embodiments also provide a spectral-efficient method using signal cancellation and forwarding so that an ns-BS could schedule its own SS transmission even using the resource overlapped with the SS in CoMP operation.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communications network wherein a plurality of base stations are capable of performing a coordinated multipoint communication with at least one subscriber station, a base station comprising:
at least one antenna configured to receive a signal, the signal comprising a data burst from the at least one subscriber station to a serving base station; and
a controller coupled to the at least one antenna, wherein the controller is configured to decode the data burst locally and, if the data burst is successfully decoded, forward the decoded data burst to the serving base station.

2. The base station as set forth in claim 1, wherein the controller is configured to forward the decoded data burst only if the serving base station fails to successfully decode the data burst.

3. The base station as set forth in claim 2, wherein controller transmits an ACK prior to forwarding the decoded data burst.

4. The base station as set forth in claim 2, wherein controller partitions the decoded data into a plurality of segments and forwards the plurality of segments separately.

5. The base station as set forth in claim 2, further comprising a timer, and wherein the controller is configured to start the timer in response to receiving the data burst and forward at least one of the data and the signal after expiration of the timer.

6. The base station as set forth in claim 1, wherein when the controller fails to decode the data burst, the controller forwards the signal to the serving base station.

7. The base station as set forth in claim 1, wherein the controller is configured to determine if the base station is supposed to forward the decoded data burst.

8. The base station as set forth in claim 1, wherein the controller is configured to cancel signals transmitted from a plurality of subscriber stations located within a coverage area of the base station.

9. For use in a wireless communications network wherein a plurality of base stations are capable of performing a coordinated multipoint communication with at least one subscriber station, a base station comprising:
at least one antenna configured to receive a data burst from the at least one subscriber station; and
a controller coupled to the at least one antenna, wherein the controller is configured to at least one of:
decode the data burst locally; and
if unable to successfully decode the data burst, receive one of the data burst and decoded data from a second base station.

10. The base station as set forth in claim 9, wherein the controller is configured to request that the at least one subscriber station retransmit the decoded data burst if the second base station fails to successfully decode the data burst.

11. The base station as set forth in claim 9, wherein, when the controller decodes the data burst, the controller is configured to multicasts a message indicating a successful decoding of the data burst.

12. The base station as set forth in claim 9, wherein the controller is configured to jointly process the data burst received from the at least one subscriber station and the data burst received from the second base station.

13. The base station as set forth in claim 9, wherein the controller is configured to determine if the second base station successfully decodes the data burst.

14. The base station as set forth in claim 9, wherein the controller is configured to allocate an uplink burst for the at least one subscriber station and inform the subscriber station and the second base regarding the uplink burst allocation.

15. The base station as set forth in claim 9, wherein controller is configured to transmit a NACK if unable to successfully decode the data burst.

16. The base station as set forth in claim 9, wherein controller is configured to transmit and receive at least one of an ACK/NACK message and the at least one of the data burst and the decoded data via a backhaul connection with the second base station.

17. For use in a wireless communications network wherein a plurality of base stations are capable of performing a coordinated multipoint communication with at least one subscriber station, a method comprising:
receiving a signal comprising a data burst from the at least one subscriber station to a serving base station;
decoding the data burst locally; and
if the data burst is successfully decoded, forwarding the decoded data burst to the serving base station.

18. The method as set forth in claim 17, wherein forwarding comprises forwarding the decoded data burst only if the serving base station fails to successfully decode the data burst.

19. The method as set forth in claim 18, wherein forwarding comprises sending an ACK prior to forwarding the decoded data burst.

20. The method as set forth in claim 18, wherein forwarding comprises partitioning the decoded data into a plurality of segments and forwarding the plurality of segments separately.

21. The method as set forth in claim 18, further comprising:
starting the timer in response to receiving the data burst;
and wherein forwarding comprises forwarding at least one of the data and the signal after expiration of the timer.

22. The method as set forth in claim 17, further comprising:
if the data burst is not successfully decoded, forwarding the signal to the serving base station.

23. The method as set forth in claim 17, further comprising:
determining if the base station is supposed to forward the decoded data burst.

24. The method as set forth in claim 17, further comprising:
cancelling signals transmitted from a plurality of subscriber stations located within a coverage area of the base station.
